(19) United States
(12) Patent Application Publication
(10) Pub. No.: US 2009/0090592 A1
(43) Pub. Date: Apr. 9, 2009

(54) High-Frequency Anti-Lock Clutch System and Method

(75) Inventors: Gregory Mordukhovich, Bloomfield Hills, MI (US); Andrew W. Phillips, Saline, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 11/867,864

(22) Filed: Oct. 5, 2007

(51) Int. Cl. F16D 23/00; F16D 31/00; G06F 19/00

(52) U.S. Cl. 192/58.2; 192/30 V; 701/68

(57) ABSTRACT

A clutch assembly is provided including a controller, a plurality of vibration sensors, a clutch housing containing a lubricated clutch pack having a friction interface, a clutch piston responsive to a current command from the controller and operable for applying a compression force on the clutch pack, and a high-frequency (HF) oscillation source configured to generate at least one HF oscillation, and to direct the HF oscillation to the friction interface, wherein the controller is operable to detect clutch shudder and activate the source in response thereto to minimize the clutch shudder. The source includes HF hardware, and generates different HF oscillations applied directly to the clutch housing or to the clutch-apply current command. A method of reducing clutch shudder includes setting a threshold clutch shudder amplitude, detecting clutch shudder, and applying a HF oscillation to a friction interface to minimize clutch shudder when the detected shudder exceeds the threshold.

### TECHNICAL FIELD

The present invention relates to an anti-lock clutch system having a wet clutch pack with at least one pair of mating clutch plates forming a friction interface therebetween, the anti-lock clutch system being configured to introduce a high-frequency (HF) oscillation to the friction interface in order to minimize clutch vibration or shudder.

### BACKGROUND OF THE INVENTION

In an automotive transmission, clutch assemblies or clutches are commonly used to transmit rotational motion or torque between two disparately rotating members, such as an engine crankshaft and a transmission driveshaft. Standard friction-type clutches generally include a series of alternating friction and reaction plates that together make up a clutch pack, with the clutch pack being disposed within a clutch drum contained within an outer clutch housing. A friction plate typically has a layer or surface coating of rough friction material which is bonded or otherwise attached to the primary contact surfaces of the friction plate, while the reaction plate typically has a relatively smooth contact surface configured to oppose the friction plate whenever the friction clutch is engaged. A friction-type clutch is engaged by applying an actuation force, such as a controllable hydraulic force supplied by a transmission pump. This clutch-apply force actuates an apply mechanism, such as a clutch-apply piston, in order to compress or force together the various friction and reaction plates of the clutch pack. Once compressed, the alternating clutch plates become interlocked due to the substantial friction forces imparted by the combined effect of the clutch-apply force and the friction material, thereby allowing the clutch plates to rotate in unison.

Friction clutches may be of the dry-plate or wet-plate variety, with wet-plate or fluid lubricated friction clutches providing enhanced thermal performance due to the cooling qualities of the pressurized lubricating fluid. Within a wet-plate clutch, which may take the form of, for example, a shift clutch, torque converter clutch, limited slip differential, or other such lubricated clutching device, enhanced thermal performance is accomplished by passing or directing the pressurized fluid, such as transmission fluid or oil, through and around the mating clutch surfaces to dissipate the heat generated by the friction forces in proximity to the friction interface. At high temperatures, or under high apply pressures and/or low relative velocities or slip speed between the opposing surfaces forming a friction interface, there may be little or no remaining fluid film separating the opposing surfaces. This temporary absence of lubrication at the friction interface may lead to strong local adhesive bonds between opposing surfaces or friction elements, and thus may cause a spike in the coefficient of friction at the friction interface. When this change in friction is related to a change in slip speed, the effect can be approximated mechanically as negative damping, which can combine with existing powertrain resonance to create regenerative and often noticeable and objectionable clutch “shudder” or “chatter” under certain vehicle operating conditions.

In order to reduce or minimize clutch shudder, friction modifiers or boundary lubrication additives are often added to the lubricant. However, these friction modifiers may be expensive, and they are depleted over time, requiring frequent replenishment. Also, enlarging the clutch or adding a larger clutch damper may also help to alleviate clutch shudder, although such solutions generally are less than optimal due to the added cost, size, and/or weight of such larger devices.

### SUMMARY OF THE INVENTION

Accordingly, a clutch assembly is provided having a pair of clutch plates forming a friction interface therebetween, and including a controller, at least one sensor configured to detect clutch vibration, and a controllable source of high-frequency oscillation, wherein the controller is configured to activate the source of high-frequency oscillation in response to the sensor to thereby apply a high-frequency oscillation to the friction interface to minimize clutch vibration.

In one aspect of the invention, the source includes high-frequency hardware, and the high-frequency oscillation includes a plurality of different high-frequency oscillations each having a different amplitude and frequency.

In another aspect of the invention, the high-frequency hardware is configured to deliver a plurality of different high-frequency oscillations to the clutch housing.

In another aspect of the invention, a controllable clutch actuation device is responsive to a current command from the controller, wherein the source of high-frequency oscillation is configured to apply the at least one high-frequency oscillation to the controllable clutch actuation device.

In another aspect of the invention, the high-frequency oscillation is an AC component that is added to the current command for the clutch actuation device.

In another aspect of the invention, a lubricated clutch assembly is provided including a controller, a plurality of vibration sensors, a clutch housing at least partially containing a lubricated clutch pack having at least one friction interface, a hydraulically-actuated clutch piston responsive to a current command from the controller and operable for applying a compression force on the clutch pack in response thereto, and an oscillation source configured to generate at least one high-frequency oscillation in response to the controller, and to direct the oscillation to the friction interface, wherein the controller is operable to detect shudder of the clutch assembly and activate the oscillation source in response thereto for minimizing clutch shudder.

In another aspect of the invention, a method of reducing clutch shudder is provided for use in a clutch having a controller and a clutch pack disposed within a clutch housing, the clutch pack having at least one friction interface therein and the clutch being actuatable in response to a current command from the controller, the method including setting a threshold clutch shudder frequency and amplitude, detecting clutch shudder, and applying a high-frequency oscillation to the friction interface when the detected clutch shudder exceeds the threshold, thereby minimizing the clutch shudder.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic graphical illustration of the relationship between the coefficient of friction (μ) and slip speed (ν) of the clutch assembly of the invention;

FIG. 2A is a schematic exploded perspective view of a representative clutch pack usable with the invention;

FIG. 2B is a schematic graphical illustration of clutch plate surface asperities;

FIG. 3 is a fragmentary cross-sectional side view of a portion of a clutch assembly according to the invention;

FIG. 4A is a schematic graphical illustration showing the effect on the relationship between the coefficient of friction (μ) and slip speed (ν) of a high frequency (HF) oscillation applied to the friction interface, in accordance with the invention;

FIG. 4B is another schematic graphical illustration showing the effect on the relationship between the coefficient of friction (μ) and slip speed (ν) of an additional high frequency (HF) oscillation applied to the friction interface; and

FIG. 5 is a flow chart describing a method or algorithm of the invention.

### DESCRIPTION OF THE PREFERRED EMBODIMENTS

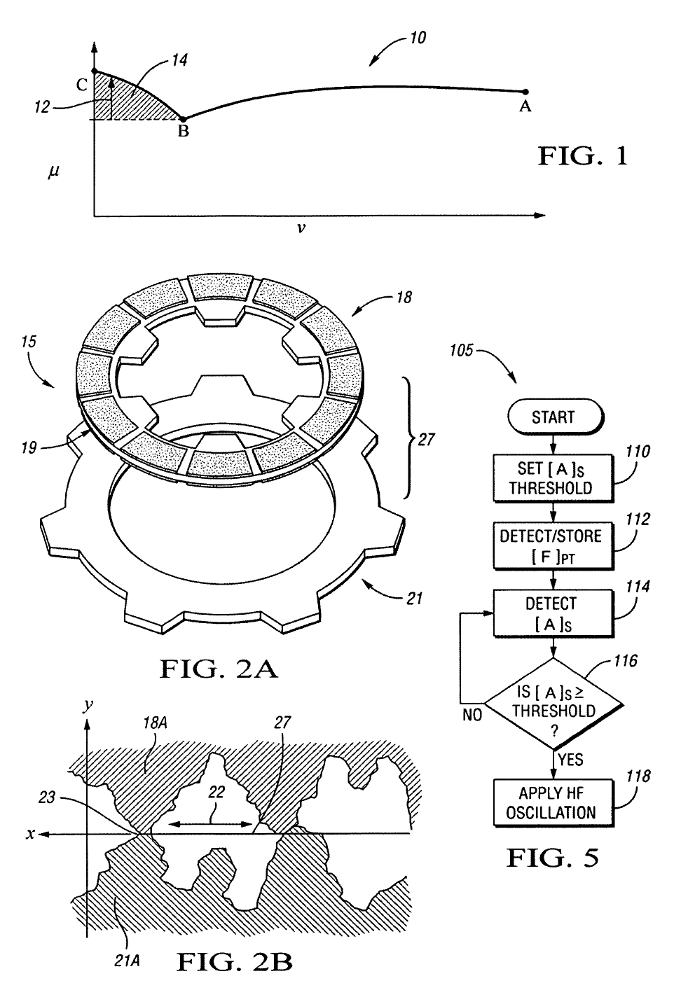

Referring to the drawings wherein like reference numbers correspond to like or similar components throughout the several figures, there is shown in FIG. 1 a schematic graphical illustration or curve 10 describing the relative relationship between the coefficient of friction (μ) and slip speed (ν) occurring between two mating clutch plates at a friction interface formed therebetween. As used herein, the term “coefficient of friction” refers generally to the ratio of the force of friction between two bodies, i.e. the two opposing clutch plates in a wet clutch pack and the force pressing the bodies or clutch plates together. For example, a representative clutch pack 15 is shown in FIG. 2A having a friction plate 18 with friction material 19 bonded or otherwise attached thereto on both sides, and an opposing reaction plate 21, with the friction interface 27 representing the mating surfaces of the respective plates 18, 21. In the perspective view of FIG. 2A, only one surface of friction plate 18 is visible, however as stated above the reverse or opposite surface (not shown) is preferably identically configured with friction material 19. The clutch pack 15 also may take the form of alternating unitary clutch plates (not shown) each having friction material 19 bonded to both sides, or any other combination of clutch plates forming a friction interface 27 having opposing surfaces with a coefficient of friction (μ) therebetween.

Turning back to FIG. 1, point A on curve 10 generally represents a condition of relatively high slip speed (ν), i.e. the difference in rotational speed between mating clutch plates, and the coefficient of friction (μ). Such a condition generally occurs during a predominantly hydrodynamic lubrication regime, or the lubrication regime in which a comparatively thick layer or wedge of lubricating fluid is formed between the rotating bodies, such as the clutch plates 18, 21 of a clutch pack 15 (see FIG. 2A). Moving from point A along curve 10, the slip speed (ν) gradually decreases to point B, upon which the surface asperities 18A and 21A (see FIG. 2B), i.e. the roughness profile of mating clutch plate surfaces 18 and 21, respectively, begin to emerge from or “poke through” the thinning oil wedge, and gradually coming into direct mutual contact. This reduction in film thickness may also occur due to elevated temperature, changes in viscosity, and/or increased or elevated apply pressure, as understood by those of ordinary skill in the art.

Turning to FIG. 2B, which depicts representative surface asperities 18A and 21A, with the height of the surface asperities 18A and 21A shown along the y-axis, and the width of the surface asperities 18A and 21A shown along the x-axis. As the surface asperities 18A and 21A come into direct mutual contact, strong adhesive bonds 23 are formed therebetween, which can result in a sharp increase or spike in the coefficient of friction (μ) as relative velocity or slip speed (ν) continues to slow. This sharp increase or spike is represented on curve 10 of FIG. 1 as the shaded area 14 having a maximum amplitude 12 at point C, i.e. at zero slip speed (ν). Reduction of amplitude 12 of area 14 effectively reduces the amount or degree of perceived clutch vibration or shudder. Therefore, breaking the adhesive bonds 23 that form between the surface asperities 18A, 21A during boundary lubrication conditions effectively flattens or reduces the amplitude 12, and therefore is an object of this invention, as will now be explained.

The introduction of a high-frequency (HF) vibration or oscillation directly or indirectly to the friction interface 27 (also see FIG. 2A) before the onset of or during a clutch shudder event facilitates the breaking of the adhesive bonds 23. While some degree of hydrodynamic lubrication still exists at the friction interface 27, that is, some level of film thickness remains within the friction interface 27, a properly selected HF oscillation component superimposed on the nominal velocity profile or curve 10 of FIG. 1, will effectively further flatten, “smear”, or otherwise filter curve 10 in the ν-direction. This result can be best seen in FIG. 4A, with shaded area 114 replacing shaded area 14 of FIG. 1, with the “smearing” effect due to the relative motion of surface asperities 18A and 21A, represented by arrow 22 in FIG. 2B, generating a film thickness therebetween.

As the film layer or oil wedge continues to thin, the surface asperities 18A and 21A (see FIG. 2B) come into direct, non-lubricated contact, and a boundary lubrication condition commences. While operating under a boundary lubrication regime, the introduction of a properly selected HF-component or oscillation forces or causes a greater number of surface asperities 18A, 21A to be bypassed or “skipped over” during the high-slip portion of the speed cycle, that is, the portion of curve 10 to the left of point B. This “skip effect” is more pronounced as the slip speed (ν) approaches zero. The result of the properly applied HF-component is shown in FIG. 4B, as the shaded area 214 formed between points C′ and B′.

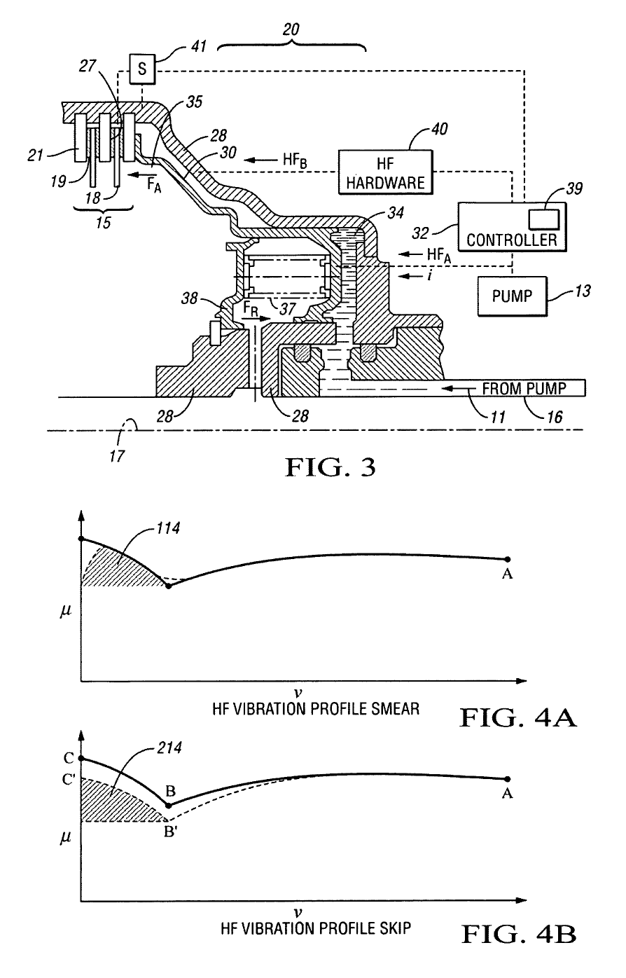

Turning now to FIG. 3, a representative clutch assembly 20 is shown in a cutaway side view having an axis of rotation 17 and a clutch housing 28 containing a hydraulically-actuated clutch apply piston 30 separating a clutch-apply cavity 34 from a main cavity 35. For simplicity, only one half of the symmetrical clutch assembly 20 is shown relative to the axis of rotation 17. The clutch-apply piston 30 is preferably biased by a return spring 37 disposed or positioned between the clutch-apply piston 30 and a substantially stationary balance piston 38, the return spring 37 having a suitable return force, as represented by arrow F_{R}. Pressurized fluid 11 is fed into the clutch-apply cavity 34 from a controllable source or pump 13, such as a positive displacement pump, through a fluid passage 16. The pump 13 is variably and selectively controllable as required by a controller 32 having memory 39. The clutch-apply piston 30 is engageable with a clutch pack 15 having at least one reaction plate 21 and at least one friction plate 18, as previously described hereinabove, with either or both of plates 18 and 21 having friction material or surface 19 (also see FIG. 2A). As pressurized fluid 11 is fed or directed into the clutch-apply cavity 34, the clutch-apply piston 30 slides or moves into engagement with the clutch pack 15, pressing the respective plates 18 and 21 together. The friction material 19 then slows or stops the disparately moving plates 18 and 21 to enable full engagement of the clutch pack 15, allowing for example a gear shifting event.

In one embodiment, the reduction of clutch shudder may be achieved by carefully selecting an alternating current (AC) component, represented by arrow HF_{A}, and adding this AC component HF_{A} to the current command (i) which controls the clutch-apply pressure, represented in FIG. 3 by arrow F_{A}. Controller 32 is therefore preferably configured to execute an method or algorithm 105 (see FIG. 5) contained or programmed in one or more software and/or firmware programs (not shown) to rapidly detect and/or determine the presence or absence of an impending or current clutch shudder condition, preferably using one or more vibration sensors 41 operatively connected at selected portions of the transmission and clutch assembly 20, and then apply the AC component HF_{A} via the clutch-apply piston 30 so that the clutch-apply piston 30 vibrates or resonates at a predetermined frequency. Alternately, the clutch shudder condition is detected and quantified prior to vehicle production, such as during modeling, research, development, and/or pre-production testing, and a predetermined AC-component HF_{A} is continuously applied via clutch-apply piston 30 while the vehicle is in operation.

In a second embodiment, HF vibration hardware 40 may be operatively connected to the clutch assembly 20, preferably directly to the clutch housing 28, to apply an HF-component HF_{B}, with HF vibration hardware 40 being variably controllable via the controller 32. HF vibration hardware preferably includes a plurality of simultaneously controllable vibration sources capable of generating and imparting an HF-oscillation or vibration to the clutch housing 28, each having a different frequency so as to generate a noisy signal rather than a single tone, and attached to clutch housing 28, such as an outer clutch housing or torque converter cover. Using such a device, clutch dampers (not shown) may be removed to offset any hardware costs and additional weight/space associated with the alternate HF vibration hardware 40. Alternately, as with the first embodiment, the clutch shudder condition is detected and quantified prior to vehicle production, and a predetermined oscillation or vibration HF_{B} is continuously applied via HF vibration hardware 40 while the vehicle is in operation.

A method of minimizing clutch shudder is also shown via the algorithm 105 of FIG. 5, which is preferably stored or otherwise programmed into memory 39 within controller 32 (see FIG. 3). In step 110 of the algorithm 105, the threshold shudder amplitude, noted for simplicity as [A]_{S THRESHOLD}, is set or programmed into memory 39. The shudder threshold amplitude is preferably selected by first determining the maximum amount or level of clutch shudder that is determined to be permissible or tolerable for a given vehicle design. Step 110 may be a factory-programmable variable, such as determined during pre-production vehicle testing and/or vehicle calibration, or optionally may be user-selectable for input into memory 39. Once step 110 is complete, the algorithm 105 proceeds to step 112.

In step 112, the controller 32, using the vibration sensors 41, detects the natural frequency of the clutch assembly 20 (see FIG. 3) and its associated hydraulics, noted for simplicity as the variable [F]_{C}. To simplify the design and/or programming complexity of the controller 32, [F]_{C}, which is effectively equivalent to the natural frequency of the powertrain (not shown), may be alternately determined a priori via modeling or simulation, by using a vehicle prototype, and/or by a calibration vehicle, and is stored in memory 39. The algorithm 105 proceeds to step 114.

In step 114, the controller 32, using vibration sensors 41, detects the amplitude of oscillation of any clutch vibration or shudder occurring during relatively low slip speed conditions (see FIG. 1), noted hereinafter for simplicity as the variable [A]_{S}. This quantity is then stored in memory 39, and the algorithm 105 proceeds to step 116.

In step 116, the controller 32 compares the stored shudder amplitude value [A]_{S} from the previous step to the stored threshold value, [A]_{S THRESHOLD} (see step 110). If [A]_{S} is greater than or equal to [A]_{S THRESHOLD}, the algorithm 105 proceeds to step 118. If, however, if [A]_{S} is less than the threshold value [A]_{S THRESHOLD}, the algorithm 105 repeats step 114 and 116.

In step 118, the controller 32 initiates the HF vibration or oscillation and applies it to or within the clutch assembly 20, as previously discussed hereinabove. Preferably, the stored clutch assembly natural frequency value or [F]_{C} (see step 112) is used as an approximate lower boundary or limit of the applied frequency so as to generate a significant response in the slip speed (ν) at the friction interface 27 (see FIGS. 2A, 2B, and 3). More specifically, the frequency region closely bounding [F]_{C} should be avoided so as to prevent exciting the resonant system into a regenerative response. The optimum lower boundary, as will be understood of those of ordinary skill in the art, may be determined for a given clutch assembly by testing and/or calibration, which may vary depending on the particular design of the clutch assembly and associated powertrain. However, other lower boundaries may also be used within the scope of the invention provided the applied HF oscillation is sufficient to break the adhesive bonds 23 (see FIG. 2B) as previously described hereinabove, but still having a low enough amplitude so as to not be detected by an occupant of the vehicle. Additionally, the upper boundary should be selected so as not to adversely affect the performance of the clutch-actuation device, such as clutch-apply piston 30 (see FIG. 3), i.e. with attention to the bandwidth limitations of a given actuator. Therefore, the optimum waveform of an applied HF oscillation will ultimately depend on the specific design characteristics of a given vehicle and powertrain.

Alternatively, under some circumstances initiating the HF vibration before shudder is detected and continuously applying an HF vibration to the clutch assembly 20 may be preferred in order to prevent the shudder from initiating in the first instance, and from subsequently building regeneratively upon itself. With such an alternative, steps 110, 112, and 114 would be accomplished prior to vehicle production, with step 110 preferably setting [A]_{S THRESHOLD} at a low or near zero level to ensure continuous or constant application of the HF component upon vehicle start up. In this manner, step 114 would always immediately proceed to step 118, i.e. application of the HF oscillation in a continuous or sustained manner upon vehicle start up, at a predetermined frequency and amplitude HF_{A} and/or HF_{B} suitable for minimizing the predetermined shudder condition.

While the best modes for carrying out the invention have been described in detail, those familiar with the art to which this invention relates will recognize various alternative designs and embodiments for practicing the invention within the scope of the appended claims.

1. A clutch assembly having a pair of actuatable clutch plates forming a friction interface therebetween, the clutch assembly comprising:
a controller;
at least one sensor configured to detect shudder of the clutch assembly; and
a controllable source of high-frequency oscillation;
wherein said controller is configured to activate said source in response to said detected shudder to thereby apply at least one high-frequency oscillation to the friction interface for minimizing said detected shudder.

2. The clutch assembly of claim 1, wherein said controllable source includes high-frequency hardware, and wherein said at least one high-frequency oscillation includes a plurality of different high-frequency oscillations each having a different amplitude and frequency.

3. The clutch assembly of claim 2, including a clutch housing, wherein said high-frequency hardware is configured to deliver said plurality of different high-frequency oscillations directly to said clutch housing.

4. The clutch assembly of claim 1, including a controllable clutch actuation device responsive to a current command from said controller, wherein said controllable source of high-frequency oscillation is configured to apply said at least one high-frequency oscillation to said controllable clutch actuation device.

5. The clutch assembly of claim 4, wherein said at least one high-frequency oscillation is an AC component that is added to said current command.

6. A lubricated clutch assembly comprising:
a controller;
a plurality of vibration sensors;
a clutch housing at least partially containing a lubricated clutch pack having at least one friction interface;
a hydraulically-actuated clutch piston responsive to a current command from said controller, and operable for applying a compression force on said clutch pack in response thereto; and
an oscillation source configured to generate at least one high-frequency oscillation in response to said controller, and to direct said oscillation to said friction interface; wherein said controller is operable to detect shudder of the lubricated clutch assembly and is operable to activate said oscillation source in response thereto for minimizing said detected shudder.

7. The clutch assembly of claim 6, wherein said oscillation source includes high-frequency hardware, and wherein said at least one high-frequency oscillation includes a plurality of high-frequency oscillations each having a different amplitude and frequency.

8. The clutch assembly of claim 6, wherein said high-frequency oscillation is applied directly to said clutch housing.

9. The clutch assembly of claim 6, wherein said oscillation source is configured to apply said at least one high-frequency AC component having a predetermined frequency and amplitude to said current command so that said clutch piston vibrates at said predetermined frequency and amplitude.

10. A method of reducing clutch shudder in a wet clutch having a controller and a clutch pack disposed within a clutch housing, the clutch pack having mating surfaces forming at least one friction interface therebetween, and said wet clutch being actuatable in response to a current command from said controller, the method comprising:
setting a threshold clutch shudder amplitude;
detecting the clutch shudder of the wet clutch; and
applying a high-frequency oscillation to the friction interface when said detecting determines that the clutch shudder exceeds said threshold clutch shudder amplitude, thereby minimizing said clutch shudder.

11. The method of claim 10, including applying said high-frequency oscillation to the clutch housing to thereby vibrate the clutch housing at said high-frequency oscillation.

12. The method of claim 10, including adding said high-frequency oscillation to the current command.

13. The method of claim 10, wherein the friction interface forms a mutual adhesive bond during low slip speed, the method further including sensing said slip speed and applying said high-frequency oscillation to the friction interface to thereby break said mutual adhesive bond.
